(19) United States
(12) Patent Application Publication
(10) Pub. No.: US 2007/0150539 A1
(43) Pub. Date: Jun. 28, 2007

(54) METHOD AND APPARATUS FOR COLLABORATIVELY MANIPULATING SOURCE SCRIPTS

(75) Inventors: Connor O'Sullivan, Chicago, IL (US); Jon Godston, Chicago, IL (US); Robert Jacobs, Somerville, MA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/275,749

(22) Filed: Jan. 26, 2006

Related U.S. Application Data
(60) Provisional application No. 60/754,133, filed on Dec. 27, 2005.

(51) Int. Cl. G06F 15/16

(52) U.S. Cl. 709/204

(57) ABSTRACT

Source script (250, 260, 270) on multiple user portals is collaboratively manipulated by exchanging metadata (210) among the plurality of user portals to represent chosen segments of the source script. The metadata (210) contains properties (230-241) for the chosen segments of the source script. A common copy (250, 260, 270) of source script possessed among the plurality of user portals is initially identified. The source script, therefore, does not need to be transmitted among user portals during the collaboration because only the metadata for the common source script needs to be exchanged.

### CROSS-REFERENCE TO RELATED APPLICATION

The present application is related to an invention disclosure entitled “Mobile DJ Interface” having attorney docket number CS26126RL, U.S. patent application Ser. No. 60/754,133, filed on Dec. 27, 2005, and naming Conor P. O'Sullivan as an inventor, and subject to an obligation of assignment to the same assignee as the present application.

### BACKGROUND OF THE INVENTIONS

1. Technical Field

The present inventions relate to the creation of new works derived from existing works and, more particularly, relate to collaborative manipulation of source scripts.

2. Description of the Related Art

Remixes are forms of recorded music made by combining existing recordings in new ways. Example artists include Beck and Moby.

Turntable interfaces are known for making remixes such as that disclosed in US Patent Publication No US20040228222.

Hewlett Packard has disclosed a DJammer interface used for remixing by more than one user. The Hewlett Packard interface has a limited type of physical and gestural interaction.

There currently exists no convenient way for multiple users to interact collaboratively to perform musical sequences and create new audio content “on the fly”.

The preferred embodiments and aspects and features of the inventions will be understood from the following detailed description when read in conjunction with the accompanying drawings wherein:

### BRIEF DESCRIPTION OF THE DRAWINGS

FIG. 1 illustrates a schematic block diagram of multiple user devices to collaboratively create musical sequences according to the present inventions;

FIG. 2 illustrates a diagram of user scripts and metadata referring to them according to the present inventions; and

FIG. 3 illustrates a flow diagram of collaborative interaction among multiple user devices to create musical sequences according to the preferred embodiment of the present inventions.

### DETAILED DESCRIPTION OF THE PREFERRED EMBODIMENTS

An aspect of the present inventions is to collaboratively create remixes among multiple users.

A further aspect of the present inventions is to create remixes among geographically spaced users in real time.

A further aspect of the present inventions is to allow multiple users to interact collaboratively using self-contained mobile devices (e.g. cell phones) to perform musical sequences and create new audio content “on the fly”.

Another aspect of the present inventions is to create remixes among users via Bluetooth.

A further aspect of the present inventions is to store new remixes efficiently.

Another further aspect of the present inventions is to store without creating copies of original material.

An additional aspect of the present inventions is to exchange remixes with low bandwidth transfer.

An additional further aspect of the present inventions is to exchange remixes without content streaming (i.e. only exchange track metadata and modifiers).

A real-time, self-contained, wireless, multiple-user collaboration system with improved content management is desired.

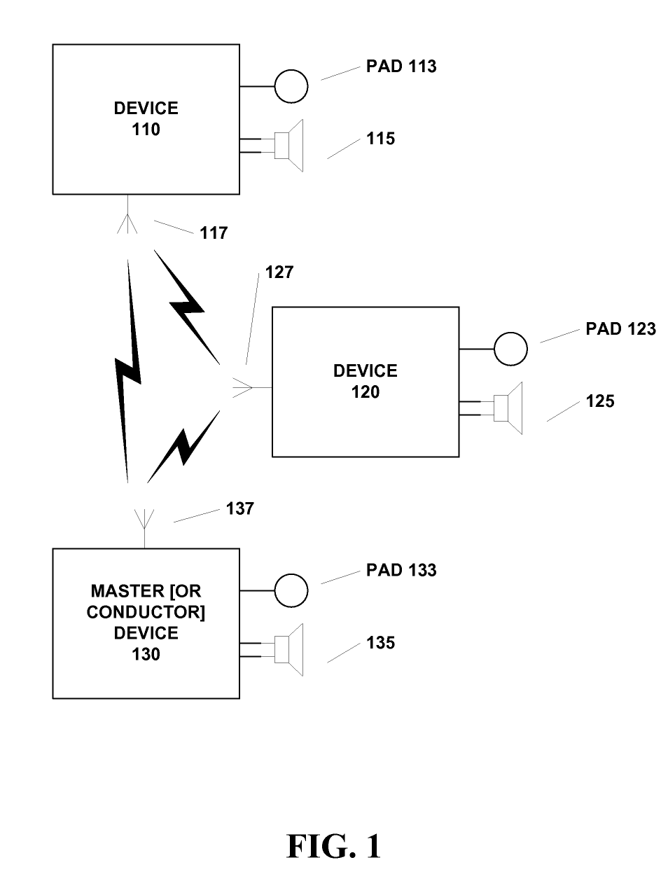

FIG. 1 illustrates a schematic block diagram of an embodiment where multiple user devices 110, 120 and 130 interact collaboratively to create sequences such as musical sequences. Each device 110, 120 and 130 has a speaker or earphone 115, 125, and 135 and a human interface such as the illustrated touchpad 113, 123 and 133. Each touchpad 113, 123 and 133 is preferably a touchscreen-enabled visual-based output display (e.g. LCD, OLED, etc.). By using a visual-based output display, the visual user interface may change “on-the-fly” with on-screen “soft-keys”. The touchscreen or pad may be round and use either polar or rectangular coordinates. Thus the human interface may be an instantiation of a scratch disc, a keypad, a touch screen, a jog-dial, a nudge-roller and a physical sensor such as a proximity sensor or accelerometer.

The human interface may give haptic feedback. Haptic is tactile feedback, e.g., any kind of physical feedback that you feel. Haptic feedback may be created with a linear or rotary vibrator, e.g. located behind a touchscreen or in a device. The device may thus have lights and vibrators that are activated by the metadata to cause remix lights and vibrations.

Further, the human interface may be a camera capable of detecting visual movement such as of an object or one's body, hand or other body part.

The plurality of devices do not need to be co-located and may be geographically separated a meaningful distance so as to require networking such as wireless Bluetooth, WiFi, cellular or infrared such as IrDA. The devices preferably interact with one another wirelessly via the antennas 117, 127 and 137. Alternatively, the device may interact in a wired or other fashion. A wireless approach according to the illustrated embodiment uses Bluetooth. One or more of the multiple devices 110, 120 and 130 may be mobile telephones or other kinds of devices such as a remote control, any mobile communication device, a digital audio player, a gaming device, and a Personal Digital Assistant (PDA).

Upon setup of a session, the multiple user devices 110, 120 and 130 check for common source script or source media on the user devices. Common source script is identified among the user devices or portals by checking data indicative of its version, e.g. through confirmation of identical digital version signatures or time duration. The source script in some embodiments is in a music file format such as WAV, WMA, MP3, OGG, MIDI and wave table. In other embodiments the source script may be an application, e.g. video game, light show, vibration patterns, virtual painting or sculpting, and video editing. One example of a video game is “SIM City”, where players work together to build a virtual city, or termites build a termite mound on an African savannah. One example of virtual painting or sculpting is graffiti on a virtual wall or a car parts sculpture in a virtual junkyard. One example of video editing is a video montage of layered, “ghosted” moving images.

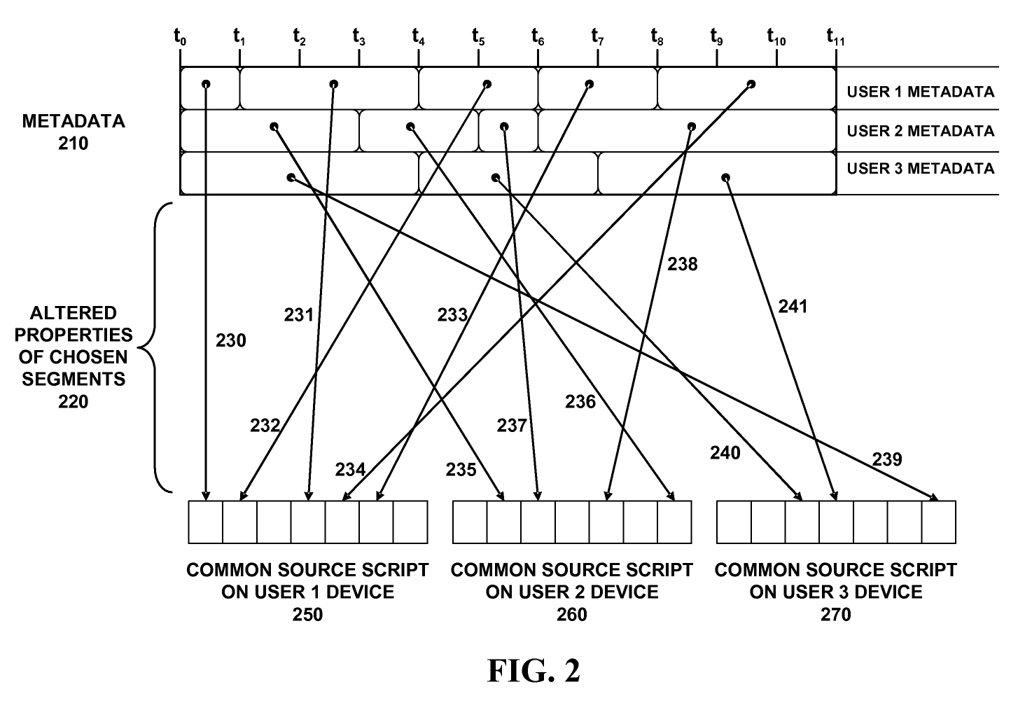

FIG. 2 illustrates a diagram of the user scripts 250, 260 and 270 and the metadata 210 referring to selected segments of the script with the altered chosen properties 230-241 of the segments. The metadata 210 identifies the altered properties of the chosen segments. The metadata 210, combined with the referenced source script, represents a remix indicative of a new, derivative script. The metadata 210 contains the individual user metadata such as that of user 1, user 2 and user 3 illustrated in FIG. 2. This provides for simultaneous capture and playback of different script segments. The metadata is preferably recorded for subsequent playback of the new, derivative script. A new, derivative script may be recorded in an audio music file format such as mp3 from the metadata and the source script. This metadata 210 is shared among the users' devices. The metadata includes time markers tₙ (t₀, t₁, t₂ . . . ) which are synchronized among the user devices. These time markers are used to synchronize the interval user contributions. Both remix creation and playback rely on this synchronization of the metadata. Because the metadata is shared, the source script or source media does not need to be shared in whole or even streamed.

The properties for each segment of the script may include the following indicia: a device key, name of song, track ID, place in time on track, filters, effects, and what to do at a place such as slower, faster, louder, softer, forward, reverse.

The metadata 210 can point to the selected segments of the common source script contained on each of the users' devices. In addition, the devices may identify common capabilities (e.g. lighting & vibration electromechanical components) of at least one of the user portals and then alter the properties of the segments based on the identified capabilities.

By way of the example of FIG. 2, property arrows 231 and 232 cross to note that the chosen segments of each user's common source script do not need to be selected or “played back” in the same order as the segments of the original source script. By way of the example of FIG. 2, the property arrows skip some segments in the common source script to note that not all of the segments of the script need to be selected or “played back” at all.

In the present inventions the common source script or source media is possessed on each device and only metadata 210 is exchanged. Because the metadata 210 refers to selected segments of the user scripts 250, 260 and 270 and because the metadata 210 provides properties for those segments of the user scripts, derivative media can be collaboratively created among users at remote locations with out transferring this source media script between the user's devices. Thus not only is bandwidth conserved, but copies of the source media are not made and exchanged, thereby possibly mitigating potential copyright concerns.

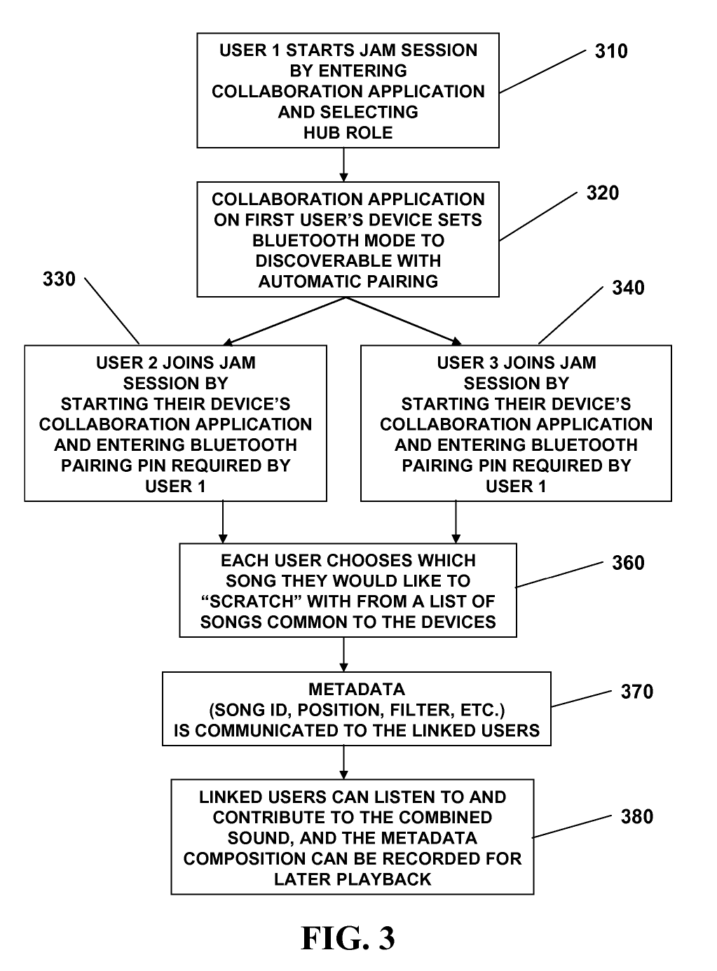

FIG. 3 illustrates a flow diagram of collaborative interaction among multiple user devices using the Bluetooth wireless protocol to create musical sequences. At step 310 a first user begins a “jam” session by entering the collaboration application on the user's device. The first user to begin the session is set up as the master by selecting the hub role. At step 320, the first user's device automatically changes the Bluetooth settings to discoverable mode with automatic pairing. This limits data sharing to only the collaboration application. Limiting data sharing helps protect against malicious code.

At step 330, the second user joins the jam session by entering the collaboration application and then entering the Bluetooth PIN required by the first user. At step 340, the third user joins the jam session by entering the collaboration application and then entering the Bluetooth PIN required by the first user. Bluetooth requires designation of a hub and a PIN such as a default of 0000. Although the present inventions describe a jam session involving only three users, it could be extended to include additional users.

At step 360, each user chooses which song from a list of songs common to all devices they would like to scratch with, and a circular buffer is used to cache the decoded audio. The songs available for jam sessions are only those that are already on the other users devices. Each user picks any of the common source script. Thus, the common source script is made available among the users for the choice. In other words, three users could “scratch” with only one song (e.g. with different filters/effects, or different segments of the song). Or each user could “scratch” with different songs, so long as the songs are common on all devices. If desired, new source script for a user device may be acquired by buying a download purchase to possess a common source script.

The circular buffer is a good way to implement using current technology. Each device's processor could (given a powerful chip) decode compressed audio “on-the-fly”. Alternatively, the audio need not even be compressed, if storage capacities of the future may allow large numbers of uncompressed songs to be stored.

At step 370, only song metadata such as the song ID, position, filter, effect, is communicated among the users through the wireless Bluetooth connection. At step 380, all linked users can contribute to the combined sound, which they can hear in real-time through their own devices such as through the speakers or headphones of the device. A new remix is thus created and can be recorded for later listening.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure. For example, although remix examples are disclosed, the inventions are applicable to live playback & performance, incoming ringtone performance, vibrate effects, video-clip edits and light shows.

What is claimed is:

1. A method of collaboratively manipulating source script on multiple user portals, comprising:
(a) identifying common copies of script possessed among the plurality of user portals; and
(b) exchanging metadata among the plurality of user portals to represent chosen segments of the source script.

2. A method according to claim 1, wherein said step (b) of exchanging metadata further comprises the substep of (b1) exchanging metadata comprising altered properties of the chosen segments.

3. A method according to claim 2,
further comprising the step of (c) identifying capabilities of at least one user portal; and
wherein said substep of (b1) exchanging metadata comprising altered properties comprises the substep of (b1i) using the identified capabilities to alter the properties of the chosen segments.

4. A method according to claim 1, further comprising the step of (c) recording at least the metadata for the chosen segments to represent a new, derivative script.

5. A method according to claim 1, wherein each of the plurality of user portals comprise memory to store its own copy of the source script.

6. A method according to claim 1, wherein the source script comprises media.

7. A method according to claim 6,
wherein the source script is audio; and
wherein the metadata represents a remix of the audio indicative of a new, derivative script.

8. A method according to claim 1, wherein the source script comprises an application.

9. A method according to claim 1, wherein in said step (b) the metadata associated with each segment comprises property data indicative of one or more of the following indicia from the group consisting of a device key, name of song, track ID, place in time on track, filters, effects, and what to do at a place such as slower, faster, louder, softer, forward, reverse.

10. A method according to claim 1, wherein each user has its own user portal.

11. A method according to claim 1, wherein each user portal is a portable electronic device.

12. A method according to claim 11, wherein the portable electronic device is selected from a group consisting of a mobile communication device, a remote control, a digital audio player, a gaming device, and a Personal Digital Assistant (PDA).

13. A method according to claim 1, wherein the metadata is shared wirelessly.

14. A method according to claim 1, wherein the metadata is shared in real time.

15. A method according to claim 1, wherein the metadata is shared without transferring the source script.

16. A method according to claim 1, wherein the source script is in a music file format selected from the group consisting of WAV, WMA, MP3, OGG, MIDI and wave table.

17. A method according to claim 1, wherein said step (b) of exchanging metadata among the plurality of user portals to represent chosen segments of the source script further comprises the substep of (b1) using a human interface at each user portal to select the chosen segments and their associated properties.

18. A method according to claim 17, wherein the human interface is selected from the group consisting of an instantiation of a scratch disc, a keypad, a touch screen, a jog-dial, a nudge-roller and a physical sensor such as a proximity sensor or accelerometer.

19. A method according to claim 1, wherein said step (a) of identifying common source script among the plurality of user portals checks data indicative of its version.

20. A method according to claim 1, wherein said step (a) of identifying common copies of source script possessed among the plurality of user portals further comprises the step of (a1) acquiring new source script for a user portal if desired to possess a source script common to other user portals.

21. A method according to claim 20, wherein each user portal comprises memory to store its own copy of the source script.

22. A portable electronic device for collaboratively manipulating source script among a plurality of users, comprising:
a human interface used to select segments of the source script and choose their properties;
a processor for checking for common source script; and
a transceiver operatively connected to the human interface to collaboratively share metadata with other users indicative of the selected segments of source script.

23. A portable electronic device according to claim 22, wherein the metadata further comprises altered properties of the chosen segments.

23. A portable electronic device according to claim 22, wherein the transceiver comprises a wireless transceiver.

24. A portable electronic device according to claim 22, wherein the human interface has haptic feedback.

25. A portable electronic device according to claim 22, wherein the human interface comprises a camera capable of detecting visual movement.

26. A portable electronic device according to claim 22, wherein the device is selected from a group consisting of a mobile communication device, a remote control, a digital audio player, a gaming device, and a Personal Digital Assistant (PDA).

27. A portable electronic device according to claim 22, wherein the device comprises memory to store its own copy of the source script.

28. A portable electronic device according to claim 22, wherein the human interface used to select is selected from the group consisting of an instantiation of a scratch disc, a keypad, a touch screen, a jog-dial, a nudge-roller and a physical sensor such as a proximity sensor or accelerometer.
